(19) United States
(12) Patent Application Publication
(10) Pub. No.: US 2017/0371988 A1
(43) Pub. Date: Dec. 28, 2017

(54) SIMULATION SYSTEM

(71) Applicant: FANUC CORPORATION, Yamanashi (JP)

(72) Inventor: Hiroshi YAMADA, Yamanashi (JP)

(21) Appl. No.: 15/632,579

(22) Filed: Jun. 26, 2017

(30) Foreign Application Priority Data
Jun. 27, 2016 (JP) 2016-126176

(51) Int. Cl. G06F 17/50; G06F 9/455; G06F 17/00; G11B 20/00

(52) U.S. Cl. CPC G06F 17/5009; G06F 17/5022; G06F 9/455; G06F 17/00; G11B 20/00

(57) ABSTRACT

A simulation system capable of synchronizing the input and output of signals between a plurality of simulation devices with the same accuracy as in the case of actual devices is provided with the plurality of simulation devices configured to perform processing in response to input signals and to output output signals and an input/output signal management device configured to output the input signals to the simulation devices and to receive the output signals from the simulation devices. The input/output signal management device stores processing response times p in the simulation devices. Virtual reception times vt of the output signals are individually calculated based on times t at which the input signals are output to the simulation devices and the processing response times p. One of the plurality of output signals received at the earliest virtual reception time vt is output as the input signal for another of the simulation devices.

### BACKGROUND OF THE INVENTION

### Field of the Invention

The present invention relates to a simulation system, and more particularly, to a simulation system capable of synchronizing the input and output of signals between a plurality of simulation devices with the same accuracy as in the case of actual devices.

### Description of the Related Art

Operations of a plurality of machine tools and robots can be synchronized by using a plurality of numerical controllers for controlling the machine tools, controllers (hereinafter referred to as “control devices”) for controlling the robots, and the like. If the control devices transmit or receive signals to or from one another, for example, control can be synchronized to achieve a coordinated operation of the machine tools and the robots.

The following is a description of an example of the coordinated operation. The controllers for the machine tools transmit machining end signals to the robots at the timing when machining by the machine tools is terminated. The control devices for the robots receive the signals and start an operation to hold machined workpieces. At the timing when the workpieces are held by the robots, the control devices for the robots transmit signals to the controllers for the machine tools, whereupon the machine tools release hold on the workpiece stockers.

Conventionally, in order to confirm the transmission and reception of input and output signals between the control devices, actual devices have been used to perform confirmation work for adjusting the timing for the signals. In recent years, however, simulation devices have come to be provided for these control devices, so that it has become possible to confirm the signal timing by using the simulation devices.

In general, however, these simulation devices are implemented on hardware different from that for the actual devices. As shown in FIG. 1, therefore, such a phenomenon occurs that the actual devices and the simulation devices are different in response processing time. If the actual devices and the simulation devices are operating on a real-time OS and a non-real-time OS, respectively, the response processing time of the simulation devices is liable to be delayed relative to that of the actual devices. Moreover, the difference in response processing time between the actual devices and the simulation devices varies depending on functions. Specifically, the delay degree that various depending on the devices and functions is not uniform. In other words, the amount of time difference in the response processing time varies for each simulation device and function. Consequently, the order of signal transmission and reception between the control devices for the simulation devices is not always the same as that for the actual devices.

Japanese Patent No. 4733695 describes a prior art technique in which a plurality of simulation devices are operated in synchronism with one another. This technique is designed so that the individual simulation devices synchronize their operations with reference to a common reference clock.

According to the technique described in Japanese Patent No. 4733695, however, although the operations of the plurality of simulation devices can be synchronized in start timing, the problem that the response processing time of the simulation devices is different from that of the actual devices is not solved. Therefore, the order of signal transmission and reception between the control devices for the simulation devices still is not always the same as that for the actual devices.

### SUMMARY OF THE INVENTION

The present invention has been made to solve the above problems, and its object is to provide a simulation system capable of synchronizing the input and output of signals between a plurality of simulation devices with the same accuracy as in the case of actual devices.

A simulation system according to one embodiment of the present invention comprises a plurality of simulation devices configured to perform processing in response to input signals and to output output signals and an input/output signal management device configured to output the input signals to the simulation devices and to receive the output signals from the simulation devices. The input/output signal management device stores processing response times p in the plurality of simulation devices, calculates virtual reception times vt of the output signals based on times t at which the input signals are output to the plurality of simulation devices and the processing response times p, and outputs one of the plurality of output signals received at the earliest virtual reception time vt as the input signal for another of the simulation devices.

A simulation system according to another embodiment is characterized in that the input/output signal management device performs processing for outputting the output signal received at the earliest virtual reception time vt with a certain time delay after processing for calculating the virtual reception times vt of the output signals from the plurality of simulation devices.

According to the present invention, there can be provided a simulation system capable of synchronizing the input and output of signals between a plurality of simulation devices with the same accuracy as in the case of actual devices.

### BRIEF DESCRIPTION OF THE DRAWINGS

The above and other objects and features of the present invention will be obvious from the ensuing description of embodiments with reference to the accompanying drawings, in which:

FIG. 1 is a diagram showing characteristics of a simulation system;

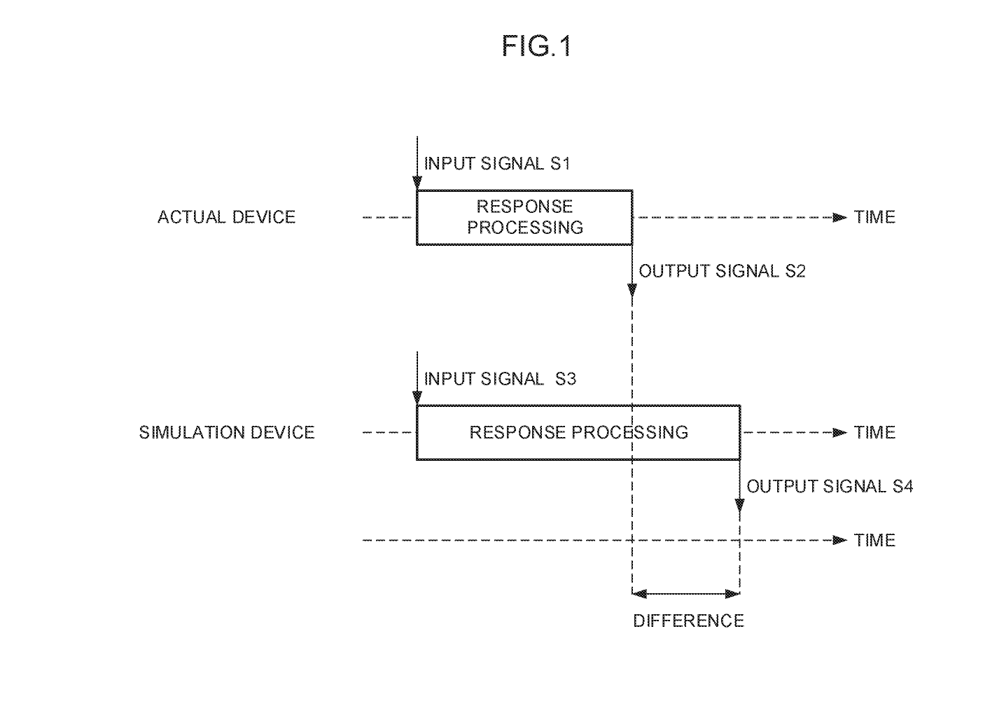

FIG. 2 is a diagram showing the configuration of a simulation system 100 according to an embodiment of the present invention;

FIG. 3 is a diagram showing the operation of actual devices 1, 2 and 3;

FIG. 4 is a diagram showing the operation of the conventional simulation system;

FIG. 5 is a diagram showing the operation of the actual devices 1 and 2;

FIG. 6 is a diagram showing the operation of the simulation system 100; and

FIG. 7 is a diagram showing the operation of the simulation system 100.

### DETAILED DESCRIPTION OF THE PREFERRED EMBODIMENTS

First, there will be described an outline of a deceleration stop function during high-speed cycle machining according to one embodiment of the present invention.

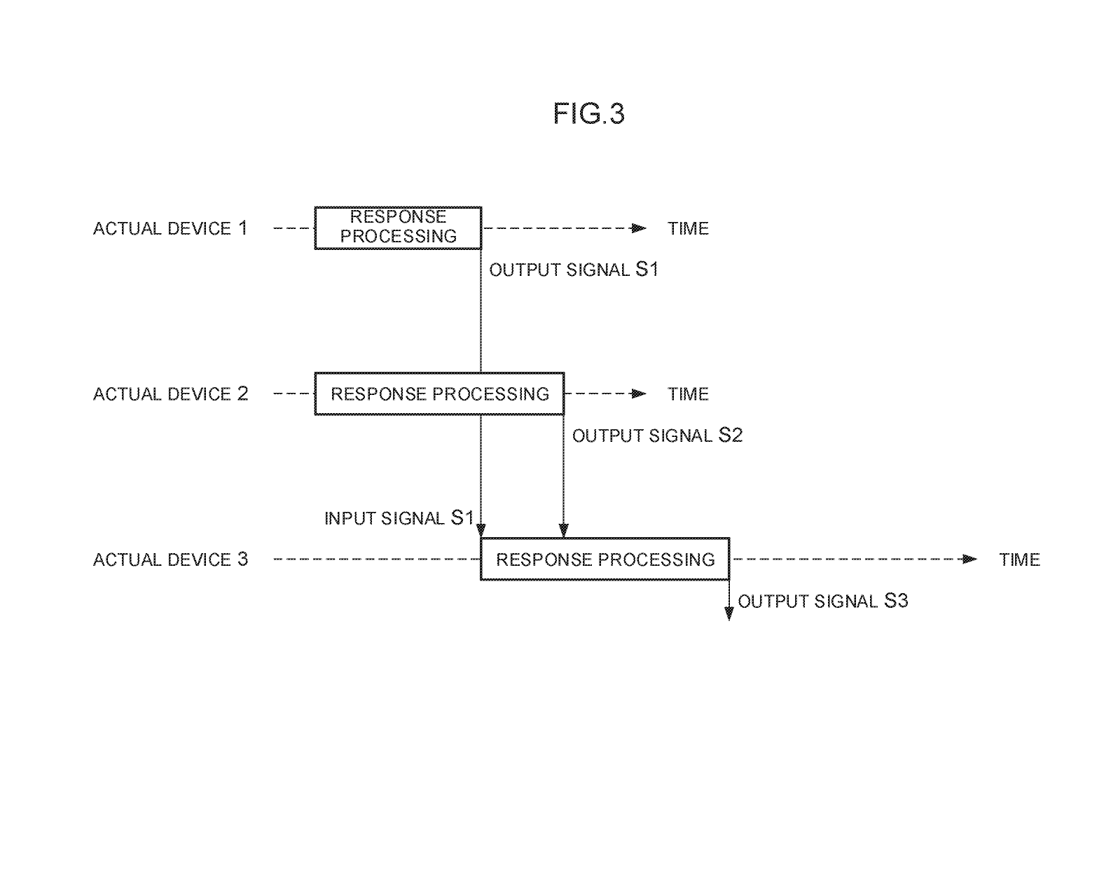

Firstly problems of a prior art technique will be described to facilitate understanding of the present invention. FIG. 3 is a diagram showing an example of signal input/output in actual devices. The actual devices 1 and 2 simultaneously start their operations. The actual device 3 is designed to start its operation on receiving the earlier of respective output signals S1 and S2 of the actual devices 1 and 2. In the example of FIG. 3, The actual device 3 receives the output signal S1 of the actual device 1 as the input signal S1.

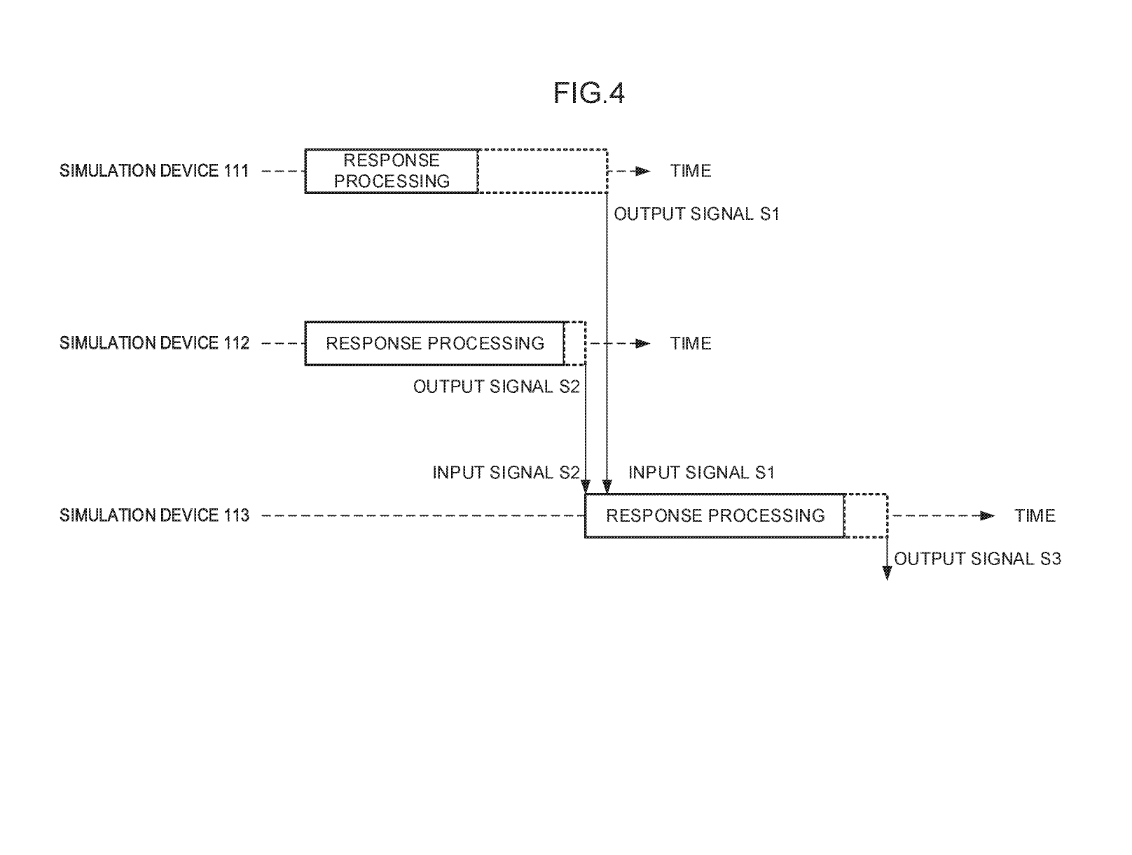

FIG. 4 is a diagram showing an example of signal input/output in simulation devices. Like the actual devices, the simulation devices 111 and 112 simultaneously start their operations. The simulation device 113 is also designed to start its operation on receiving the earlier of respective output signals S1 and S2 of the simulation devices 111 and 112. In the example of FIG. 4, the simulation device 3 receives the output signal S2 of the simulation device 2 as the input signal S2 output earlier. This is a phenomenon that is caused by an inevitable difference between the response time of the simulation devices 111 and 112 and that of the actual devices 1 and 2. In FIG. 4, this difference in response time is indicated by broken line.

Thus, the actual devices and the simulation devices may sometimes be different in the output order of the output signals S1 and S2. This is because the response processing time of the actual devices 1 and 2 is different from that of the simulation devices 111 and 112. If the order of the input/output signals varies in this manner, the operations achieved by the actual devices and the simulation devices are inevitably completely different as a whole.

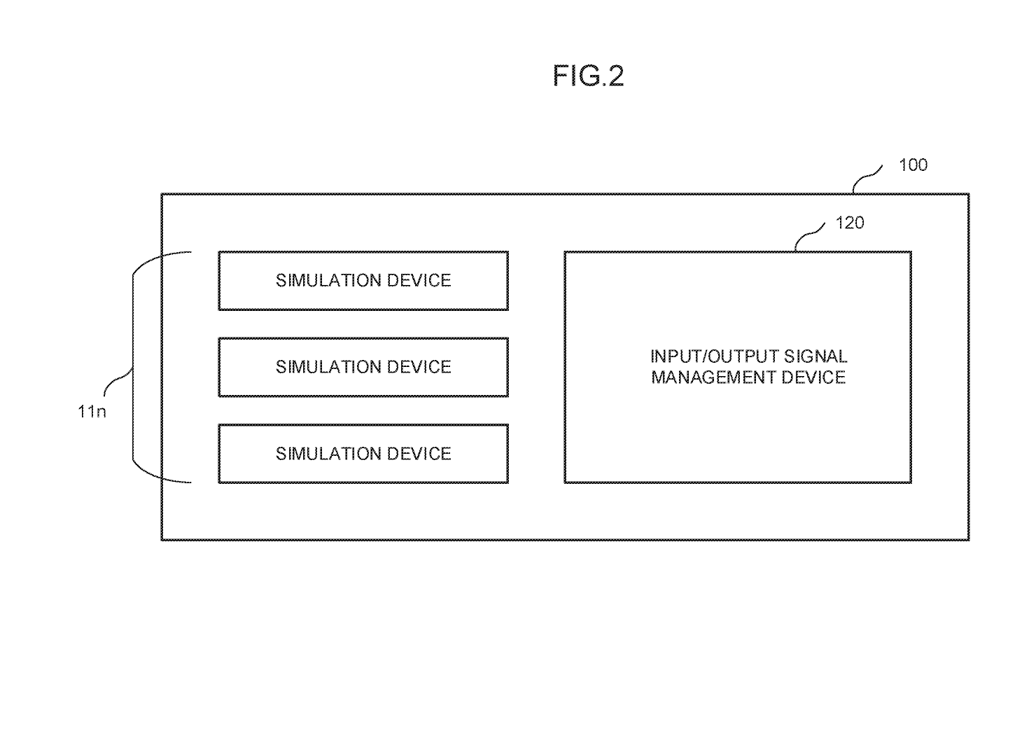

The following is a description of an embodiment of the present invention to solve this problem. The configuration of a simulation system 100 according co the embodiment of the present invention will first be described with reference to FIG. 2.

The simulation system 100 comprises a plurality of simulation devices 11n and an input/output signal management device 120. The plurality of simulation devices 11n and the input/output signal management device 120 are connected to one another for communication.

The plurality of simulation devices 11n are devices that virtually achieve their operations without activating the actual devices. Since various simulators can be used as the simulation devices 11n, a description of specific configurations is omitted herein.

The input/output signal management device 120 is a device that mediates input/output signals between the plurality of simulation devices 11n.

Typically, the simulation devices 11n and the input/output signal management device 120 are each provided with a central processing unit, storage device, and input/output device. These devices are information processing devices in which the central processing unit performs programs stored in the storage device, thereby achieving predetermined functions. The simulation devices 11n and the input/output signal management device 120 may be either implemented individually by different pieces of hardware or mounted as logically different substances on a single or distributed pieces of hardware.

The simulation devices 11n can input and output signals to and from other simulation devices 11n. In the present embodiment, however, all input and output signals are transmitted and received through the input/output signal management device 120. Thus, no signals can be directly transmitted or received between the plurality of simulation devices 11n. The simulation devices 11n receive all the input signals from the input/output signal management device 120 and transmit all the output signals to the input/output signal management device 120.

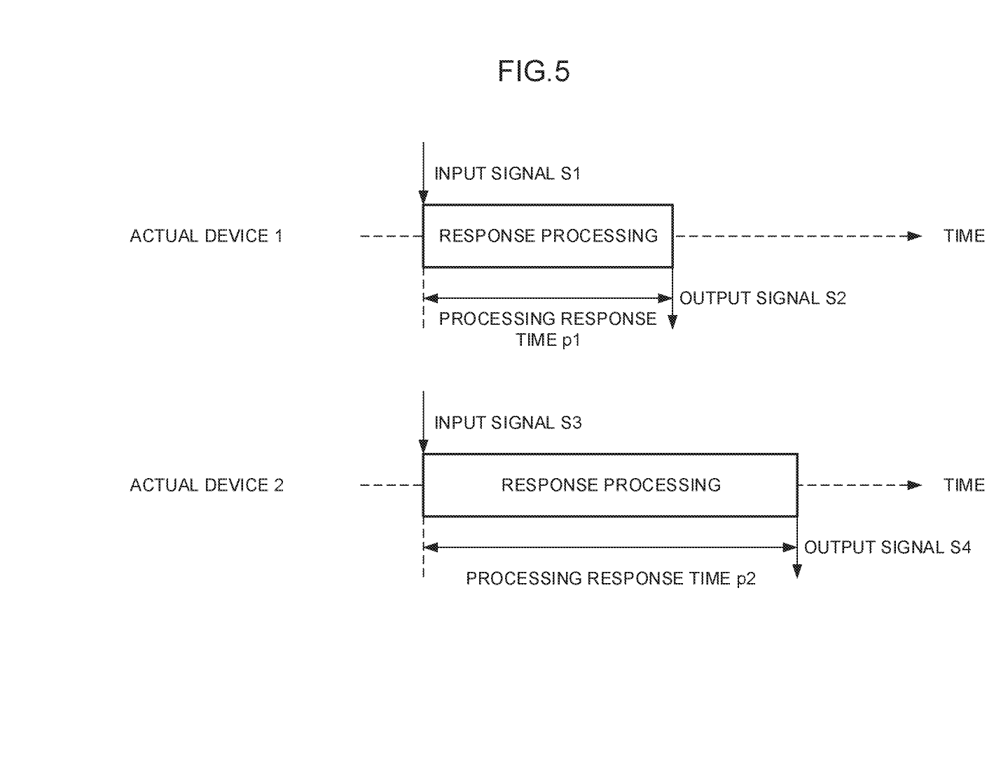

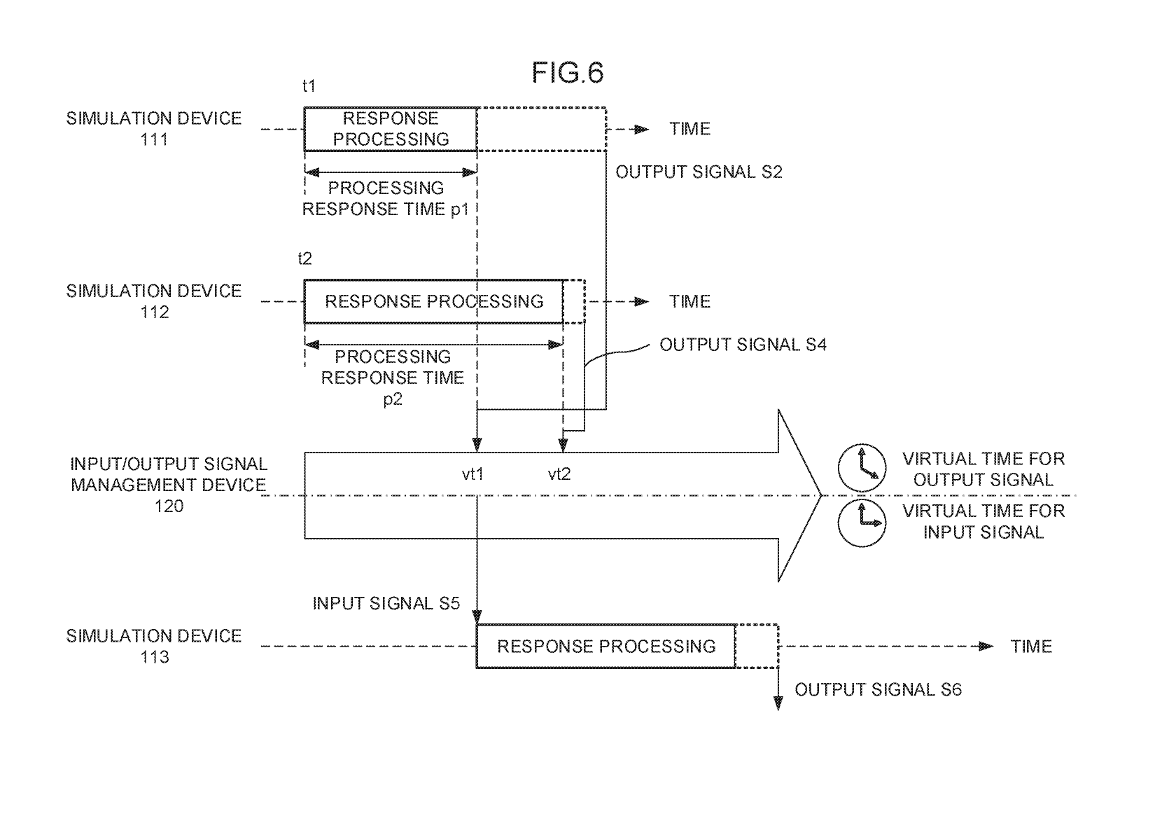

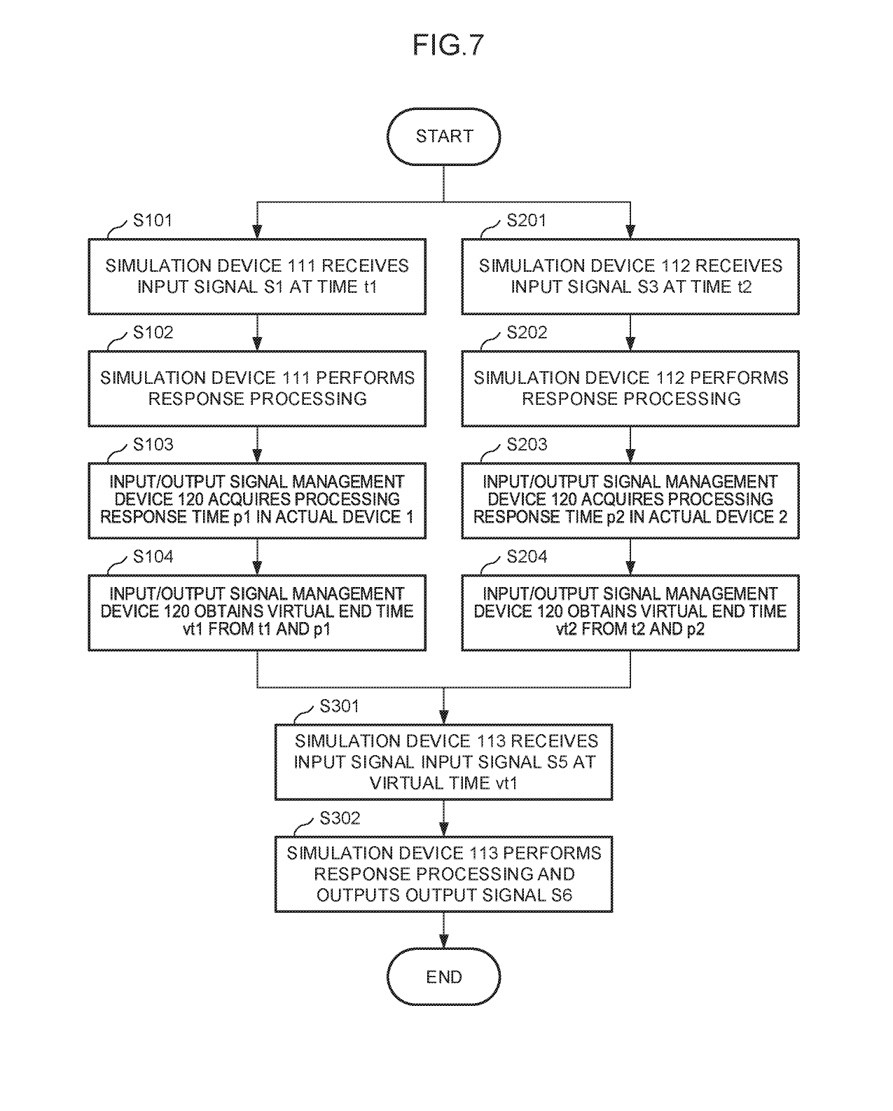

An operation example of the simulation system 100 will now be described with reference to FIGS. 5 to 7. The simulation system 100 in this example is assumed to comprise simulation devices 111, 112 and 113. Moreover, the simulation devices 111, 112 and 113 are assumed to be simulators of Actual devices 1, 2 and 3, respectively.

A coordinated operation of the actual devices 1 to 3 will now be described with reference to FIG. 5. The actual device 1 starts its operation triggered by the input signal S1 and outputs the output signal S2. The actual device 2 starts its operation triggered by the input signal S3 and outputs the output signal S4. Moreover, the actual device 3 is assumed to start its operation on receiving the output signal S2 of the actual device 1 or the output signal S4 of the actual device 2, whichever is output earlier.

The simulation devices 111 to 113 also perform a similar coordinated operation. More specifically, the simulation device 111 starts its operation triggered by the input signal S1 and outputs the output signal S2. The simulation device 112 starts its operation triggered by the input signal S3 and outputs the output signal S4. Moreover, the simulation device 113 is assumed to start its operation on receiving the output signal S2 of the simulation device 111 or the output signal S4 of the simulation device 112, whichever is output earlier.

Moreover, the input/output signal management device 120 of the present embodiment manages virtual times of two systems. Thus, it is incorporated with two clocks with different time zones the clock 1 is used to perform processing for receiving output signals from the simulation devices 11n (Steps S101 to S104 and Steps S201 to S204 described later). On the other hand, the clock 2 is used to perform processing for outputting input signals to the simulation devices 11n (Steps S301 and S302). The clock 2 is set to be delayed behind the clock 1 by a certain period of time, or more specifically, by a sufficient period of time for the output of all the output signals. In this way, the input/output signal management device 120 can output appropriate input signals after evaluating the temporal order of all the output signals.

Preprocessing:

First, the input/output signal management device. 120 loads a predetermined storage area with processing response times p1 and p2 elapsed from the reception of the input signals S1 and S3 by the actual devices 1 and 2 until the output signals S2 and S4 are output.

S101:

The simulation device 111 receives the input signal S1 from the input/output signal management device 120 at a time t1.

S102:

The simulation device 111 performs response processing and outputs the output signal S2 to the input/output signal management device 120.

S103:

The input/output signal management device 120 acquires the processing response time p1 in the actual devices from the predetermined storage area.

S104:

The input/output signal management device 120 adds the processing response time p1 to the time t1 to obtain a time vt1. The input/output signal management device 120 manages the output signal S2 as a signal received at the time vt1. Specifically, it loads, for example, the output signal S2 and the time vt1 correspondingly into a predetermined storage means.

S201:

The simulation device 112 receives the input signal S3 from the input/output signal management device 120 at a time t2.

S202:

The simulation device 111 performs response processing and outputs the output signal S4 to the input/output signal management device 120.

S203:

The input/output signal management device 120 acquires the processing response time p2 from the predetermined storage area.

S204:

The input/output signal management device 120 adds the processing response time p2 to the time t2 to obtain a time vt2. The input/output signal management device 120 manages the output signal S4 as a signal received at the time vt2. Specifically, it loads, for example, the output signal S4 and the time vt2 correspondingly into a predetermined storage means.

S301:

The input/output signal management device 120 outputs an input signal to the simulation device 113. Here the input/output signal management device 120 compares the reception times vt1 and vt2 of the output signals S2 and S4, which have already been received, and transmits Output signal S2 having reached at the earlier time vt1 as Input signal S5 to the simulation device 113.

S302:

The simulation device 113 performs response processing and outputs the output signal S6 to an output destination (input/output signal management device 120 or external device (not shown)).

As described above, the input/output signal management device 120 performs processing to output the input signal to the simulation device 113 when the time vt1 in the clock 2 is reached. The clock 2 is set to be delayed by the certain period of time behind Clock 1, which manages the reception of the output signals from the simulation devices 111 and 112. Thus, after a plurality of output signals are all output, the input/output signal management device 120 can evaluate the order relationship of virtual times at which the output signals are output and output the appropriate input signals to the simulation device 113.

According to the present embodiment, the input/output signal management device 120 calculates the output times of the output signals from the simulation devices 11n based on the processing response times of the actual devices. Moreover, the input/output signal management device 120 evaluates the output order of the output signals on the virtual times and outputs the appropriate input signals to the other simulation devices 11n. Thus, the input and output of the signals between the plurality of simulation devices 11n can be synchronized with the same accuracy as in the case of the actual devices.

While embodiments of the present invention have been described herein, the invention is not limited to the above-described embodiments and may be suitably modified and embodied in various forms.

1. A simulation system which comprises a plurality of simulation devices configured to perform processing in response to input signals and to output output signals and an input/output signal management device configured to output the input signals to the simulation devices and to receive the output signals from the simulation devices,
wherein the input/output signal management device stores processing response times p in the plurality of simulation devices, calculates virtual reception times vt of the output signals based on times t at which the input signals are output to the plurality of simulation devices and the processing response times p, and outputs one of the plurality of output signals received at the earliest virtual reception time vt as the input signal for another of the simulation devices.

2. The simulation system according to claim 1, wherein the input/output signal management device performs processing for outputting the output signal received at the earliest virtual reception time vt with a certain time delay after processing for calculating the virtual reception times vt of the output signals from the plurality of simulation devices.
